(19) United States
(12) Patent Application Publication
(10) Pub. No.: US 2004/0255173 A1
(43) Pub. Date: Dec. 16, 2004

(54) Systems and methods for using secondary system description tables

(76) Inventors: Martin O. Nicholes, Antelope, CA (US); Shiraz Ali Qureshi, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/461,610

(22) Filed: Jun. 13, 2003

(51) Int. Cl. G06F 1/26

(52) U.S. Cl. 713/300

(57) ABSTRACT

Methods for using secondary system description tables (SSDTs) are provided. One such method comprises: providing a differentiated system description table (DSDT) and a first SSDT, the first SSDT including information corresponding to a first device; and using the DSDT and the first SSDT to build an ACPI namespace that includes a first ACPI functional routine and a device tree lacking at least the first ACPI functional routine. Systems also are provided.

### BACKGROUND

The advanced configuration and power interface (ACPI) describes industry standard interfaces for computer systems. In particular, ACPI involves the use of operating systems for directing configuration and power management of such computer systems.

Computer systems employing ACPI perform configuration and power management functions using ACPI code. Specifically, ACPI code is used to determine platform-specific information regarding the particular hardware and/or software, for example, of such a computer system. Once the configuration of the computer system has been determined, the ACPI code manages the power requirements of the various devices of the computer system.

ACPI code is stored in a portion of memory of a computer system known as ACPI namespace. An operating system of a computer system typically writes ACPI code into the ACPI namespace in a monolithic form. That is, ACPI code typically is written into memory as a single program that includes all of the ACPI functionality required for each device of the computer system. Typically, the ACPI code written into memory is in the form of a device tree, which identifies each of the devices of the computer system. The device tree also includes functional routines for each of the identified devices. Clearly, this can be problematic, as there tends to be a lack of standardization of computer system configurations. In particular, various combinations of operating systems, hardware devices, and software applications are used in computer systems. Thus, ACPI code tends to lack standardization and can be somewhat complex, as the imbedded functional routines of the device tree can add significant length to the ACPI code.

### SUMMARY

Systems and methods for using secondary system description tables (SSDTs) are provided. An embodiment of one such comprises: providing a differentiated system description table (DSDT) and a first SSDT, the first SSDT including information corresponding to a first device; and using the DSDT and the first SSDT to build an ACPI namespace that includes a first ACPI functional routine and a device tree lacking at least the first ACPI functional routine.

Another embodiment of a method comprises: providing a computer system having a DSDT, a first SSDT, a first device and a memory; and using the DSDT and the first SSDT to build an ACPI namespace of the memory such that the memory includes a first ACPI functional routine and a device tree lacking at least the first ACPI functional routine.

An embodiment of a system comprises an advanced configuration and power interface (ACPI) system operative to access a DSDT and a first SSDT and to build a library and a device tree, the library including at least a first ACPI functional routine, the device tree lacking at least the first ACPI functional routine.

An embodiment of a computer-readable medium having a computer program for using an SSDT comprises logic configured to use a differentiated system description table (DSDT) and a first SSDT, the first SSDT including information corresponding to a first device to build an ACPI namespace that includes a first ACPI functional routine and a device tree lacking at least the first ACPI functional routine.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

FIG. 1 is a flowchart depicting functionality of an embodiment of an advanced configuration and power interface (ACPI) system.

FIG. 2 is a schematic diagram depicting a computer or processor-based system that can be used to implement the functionality of FIG. 1.

FIG. 3 is a schematic diagram depicting the memory of the system of FIG. 2.

FIG. 4 is a schematic diagram depicting the memory of the system of FIGS. 2 and 3 after construction of an ACPI namespace.

FIG. 5 is a schematic diagram depicting an embodiment of an ACPI namespace and interaction of a device tree and library of the ACPI namespace.

FIG. 6 is a schematic diagram depicting the ACPI namespace of FIG. 5 after addition of a secondary system description table.

### DETAILED DESCRIPTION

Systems and methods, such as the several embodiments described herein, potentially alleviate at least some of the shortcomings of prior art advanced configuration and power interface (ACPI) systems. This is accomplished by providing device trees and separate libraries of routines that include functionality associated with the device trees. Typically, a single library can support the functionality required of multiple device trees and, thus, can be device independent. For instance, a single library can be constructed for use with multiple device configurations and associated device trees, potentially resulting in economy of ACPI code design. Additionally or alternatively, a functional routine of a library can be used by multiple devices of a computer system so that multiple instances of the functional routine need not be included in the ACPI code as is typically done in the prior art.

As will be described in detail later, the exemplary systems and methods described here involve the use of differentiated system description tables (DSDTs) and secondary system description tables (SSDTs). In a given system, one DSDT and one or more SSDTs typically are provided. The DSDT and the SSDT(s) provide instructions that enable an ACPI namespace to be built. The ACPI namespace is that portion of memory of a computer system that provides the underlying functionality required for ACPI operation.

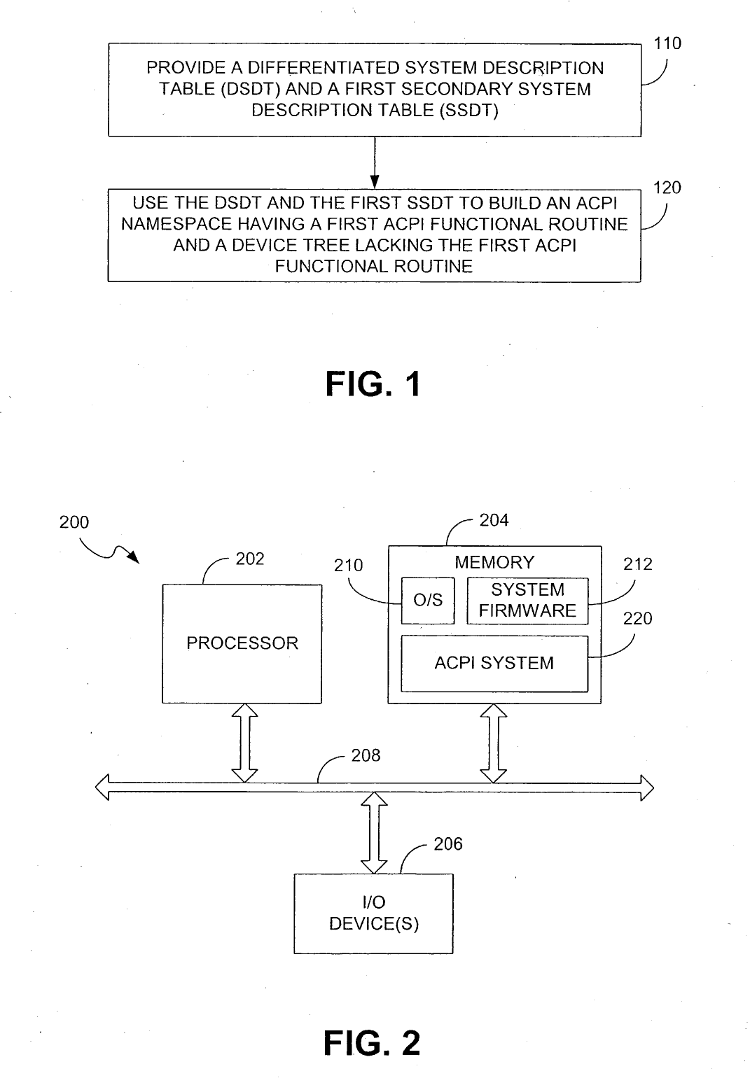

A DSDT provides base support for ACPI functionality of a computer system and, as such, is loaded into main memory for system operation. In contrast, an SSDT supplements the information contained in the DSDT and is optionally loaded into main memory, e.g., the SSDT could remain in read-only memory (ROM). Since SSDTs need not be loaded into main memory, typically, information provided by SSDTs tends to be device specific. This enables SSDTs to be loaded and/or unloaded based upon the particular configuration of the computer system with which the SSDTs are associated. For example, when a new device is added to a computer system, an associated SSDT can be added to the system and loaded into main memory prior to using the device. An embodiment of a method for using an SSDT will now be described with reference to the flowchart of FIG. 1.

In this regard, each block of the flowchart represents a module segment or portion of code that comprises one or more executable instructions for implementing the specified logical function(s). It should also be noted that, in some alternative implementations, the functions noted in various blocks, of this or any other of the flowcharts of this disclosure, may occur out of the order in which they are depicted. For example, two blocks shown in succession may, in fact, be executed substantially concurrently. In other embodiments, the blocks may sometimes be executed in the reverse order depending upon the functionality involved.

As shown in FIG. 1, an embodiment of a method for using an SSDT may be construed as beginning at block 110, where a DSDT and an SSDT are provided. Typically, the SSDT includes information corresponding to a device, such as a hardware device of the computer system with which the DSDT and SSDT are associated. In block 120, the DSDT and the SSDT are used to build an ACPI namespace that includes the ACPI functional routine(s) and a device tree that lacks the ACPI functional routine(s).

The aforementioned functionality may generally be attributed to an ACPI system that is implemented by a computer or processor-based device. An embodiment of an ACPI system is depicted schematically in FIG. 2, which will be described in detail later.

Embodiments of ACPI systems can be implemented in software, firmware, hardware, or combinations thereof. When implemented in hardware, embodiments of ACPI systems can be implemented with any or a combination of various technologies. By way of example, the following technologies, which are each well known in the art, can be used: a discrete logic circuit(s) having logic gates for implementing logic functions upon data signals, an application specific integrated circuit(s) (ASIC) having appropriate combinational logic gates, a programmable gate array(s) (PGA), and a field programmable gate array(s) (FPGA).

When implemented in software, it should be noted that embodiments of an ACPI system can be stored on a computer-readable medium for use by or in connection with a computer-related system or method. In the context of this document, a computer-readable medium is an electronic, magnetic, optical, or other physical device or means that can contain or store a computer program for use by or in connection with a computer-related system or method. Such an ACPI system can be embodied in a computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer-readable medium can be, for example but not limited to, an electronic, magnetic, optical, electromagnetic, infrared, or semiconductor system, apparatus, device, or propagation medium. More specific examples (a nonexhaustive list) of a computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

When implemented in software, an ACPI system can include a program that is executable by a digital computer, an example of which is depicted schematically in FIG. 2. In FIG. 2, computer 200 includes a processor 202, memory 204, and one or more input and/or output (I/O) devices 206 (or peripherals) that are communicatively coupled via a local interface 208.

Processor 202 can be a hardware device configured to execute software that can be stored in memory 204. Memory 204 can include any combination of volatile memory elements and/or nonvolatile memory elements. Note that memory 204 can have a distributed architecture, where various components are situated remote from one another, but can be accessed by processor 202.

The I/O device(s) 206 can include input devices such as a keypad, output devices such as a display device and/or devices that are configured to communicate both inputs and outputs such as a communication interface.

The memory 204 can include one or more separate programs, each of which comprises an ordered listing of executable instructions for implementing logical functions. Specifically, the memory 204 includes an operating system (O/S) 210 and system firmware 212. The system firmware initializes and tests hardware at startup, starts the O/S and supports the transfer of data among the hardware devices. Typically, the system firmware is stored in ROM so that the system firmware 212 can be executed when the computer system is activated: Also shown in memory 204 of FIG. 2 is an embodiment of an ACPI system 220.

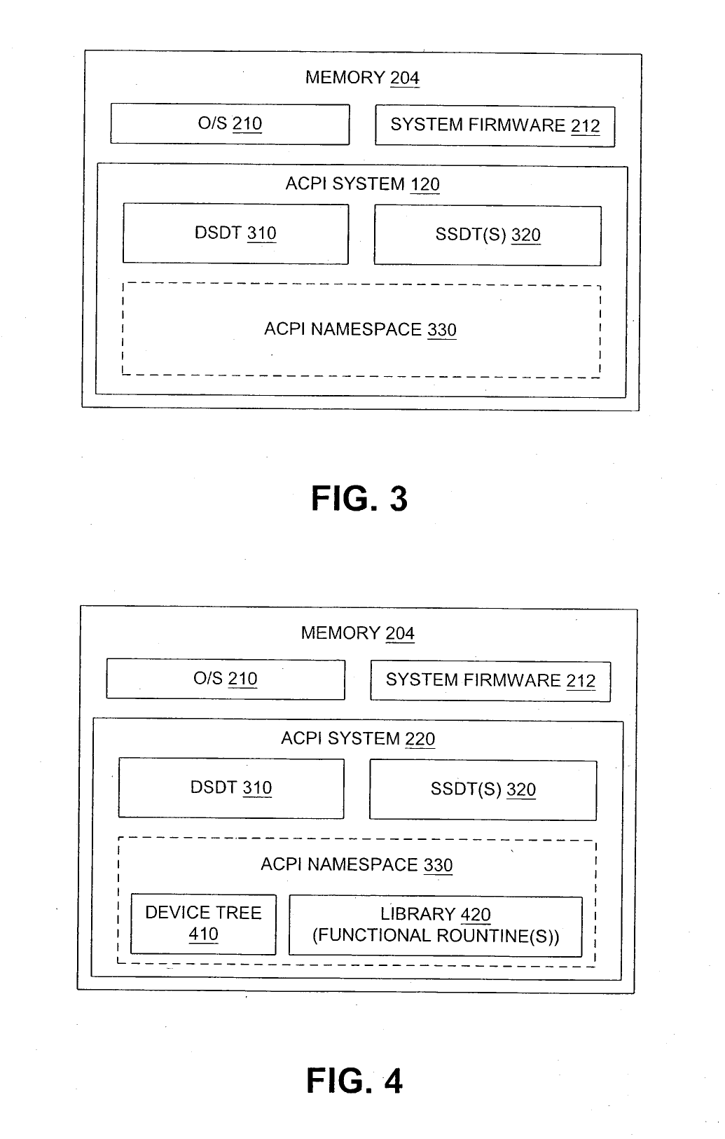

As shown in greater detail in FIG. 3, ACPI system 220 includes a DSDT 310 and one or more SSDT(s). The DSDT and the SSDT(s) provide the instructions that enable the O/S 210 to build the ACPI namespace 330, as well as the underlying functionality required for ACPI operation. Typically, the DSDT 310 and accompanying SSDT(s) 320 are loaded into main memory by the system firmware 212. The O/S 210 then analyzes the DSDT 310 and any accompanying SSDT(s) 320 written into main memory and builds the ACPI namespace 330 in accordance with the instructions.

After the ACPI namespace is built (FIG. 4), ACPI system 220 includes a device tree 410 and a library 420. The library 420 includes one or more routines, each of which provides functionality, e.g., ACPI functionality, that can be accessed by the device tree 410. Specifically, the O/S 210 builds that portion of memory 204 designated as the ACPI namespace 330 by interacting with the device tree 410. As will be described in greater detail later, the device tree 410 directs the O/S 210 to access various routines of the library 420 so that device-specific information can be provided to an appropriate location of the ACPI namespace 330.

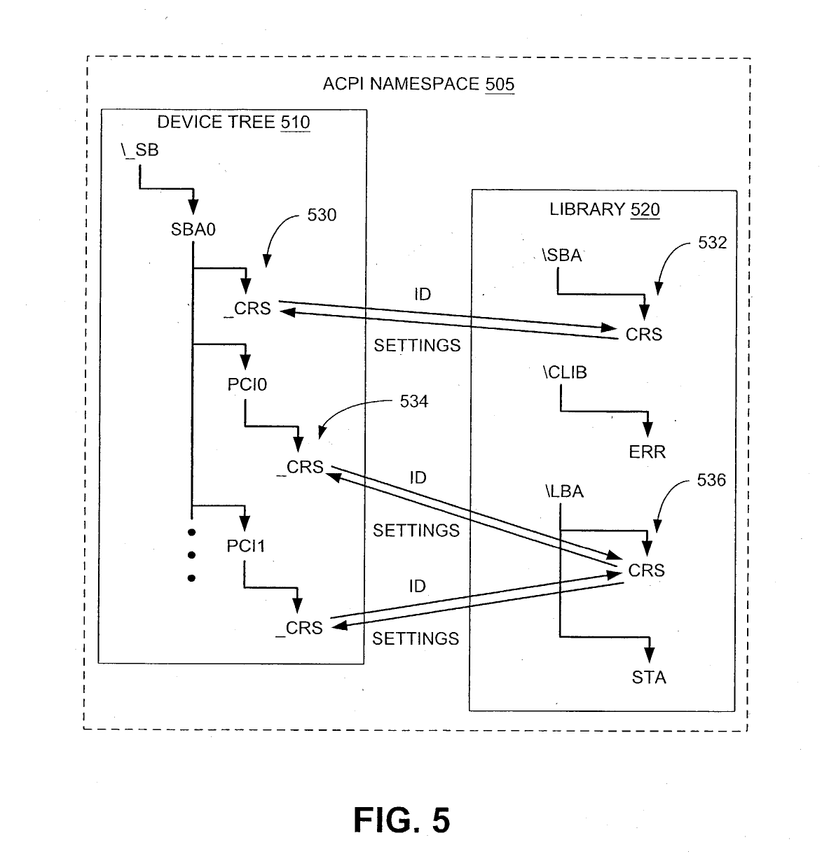

Interaction of a device tree and library of another embodiment of an ACPI system is depicted schematically in FIG. 5. As shown in FIG. 5, the ACPI namespace 505 of the ACPI system includes a device tree 510 and a library 520. Device tree 510 is a relatively simplistic code structure that describes the configuration of the computer system (not shown) with which the device tree is associated. In the portion of the device tree depicted, a system bus _SB is provided. The system bus _SB includes a system root bridge SBA0, as well as links to related devices and/or objects. Specifically, SBA0 includes a _CRS object, and system PCI host bridges, PCI0 and PCI1. Note, each of the system PCI host bridges includes a link to a corresponding _CRS object.

Library 520 is depicted as including multiple library routines, each of which includes functionality for one or more corresponding objects of the device tree 510. Specifically, library 520 includes routines that can return information about objects in the device tree 510. In operation, an operating system (not shown) reevaluates the ACPI namespace.

For example, the \SBA.CRS routine 532 returns information about the current resources settings of the particular calling object in the device tree. The calling object passes an identification number to the library routine to specify the particular object. In the case that \_SB.SBA0._CRS 530 is called in the device tree, that code calls the library routine \SBA.CRS 532, passing the caller's identification number. The library routine determines the correct values and then returns the values. Thus, the library routine CRS 532 provides functionality that enables settings of the system root bridge SBA0 to be determined and provided for use in the ACPI namespace. Note, the calls to library routines from the device tree typically are hard-coded direct calls. In some embodiments, indirect calls could be used. For example, a look-up table could be used.

Similarly, when the operating system identifies the entry point associated with _CRS 534 of system PCI host bridge PCI0, the associated library routine CRS 536 is called. This includes passing a unique device ID to CRS 536 so that CRS 536 can return the corresponding device settings for PCI0. Note that the CRS function associated with PCI1 also uses library routine CRS 536. Thus, multiple devices of the device tree 510 utilize the same portion of ACPI code of the library 520 for providing the required functionality. Because of this, multiple instances of code may not need to be provided within a library for use with similar devices.

Another example is the \CLIB.ERR library routine that can be called from locations in the code where an error needs to be handled. This allows centralized error-handling in the ACPI library and device tree. In this way, an error code can be passed to the central routing for logging.

Note, various functional objects other than _CRS can be used. By way of example, other objects such as _STA, _HID and _PRT, can be used. Specifically, _STA is an object that returns the status of a device, e.g., whether the device is enabled, disabled or removed. _HID is an object that provides the Plug-and-Play hardware ID of a device. _PRT is an object that describes the PCI interrupt routing in use under a PCI bridge device.

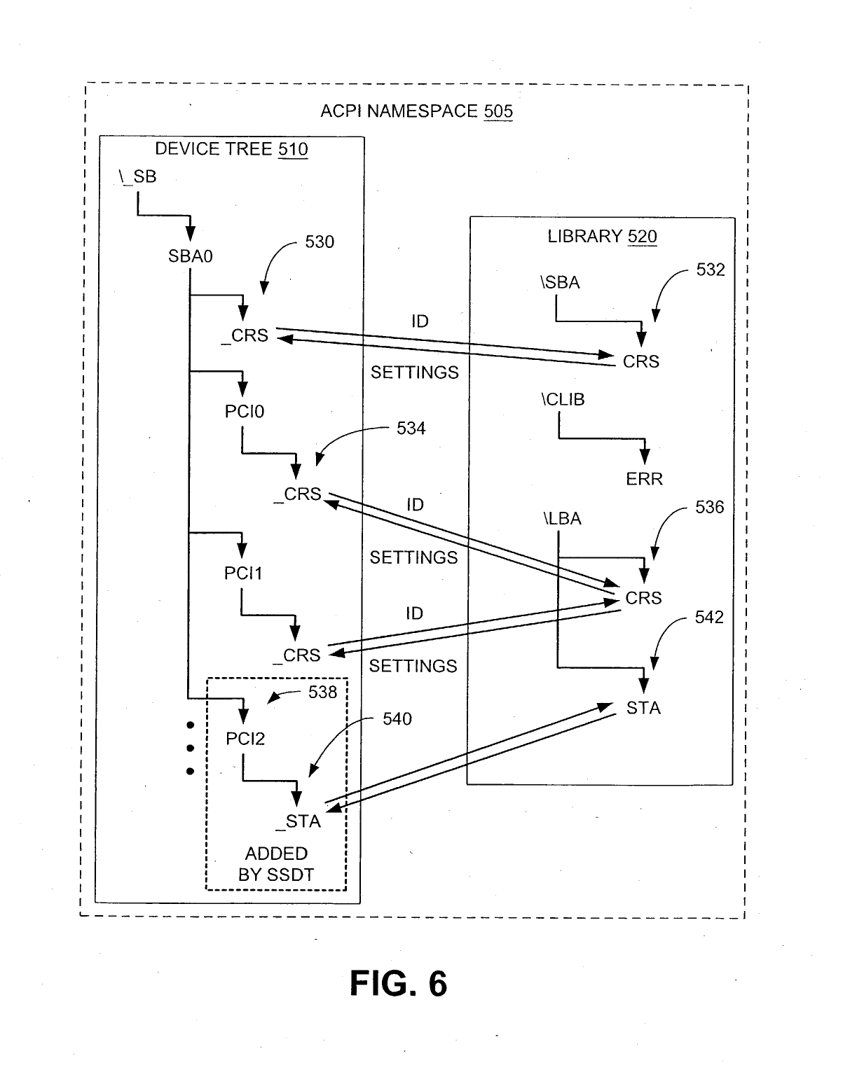

FIG. 6 schematically depicts ACPI namespace 505 after the addition of information provided by an SSDT. Specifically, in this example, the SSDT has been added to provide information corresponding to a newly added PCI bridge, i.e., PCI2. Included in the information provided by the SSDT is an _STA object, i.e., _STA 540. Thus, in the case that _STA 540 is called in the device tree, that code calls the library routine \LBA.STA 542. In response to the call and the accompanying identification information, the library routine STA 542 determines the correct values and returns the values to the operating system. Note, the functionality associated with the routine \LBA.STA 542 typically is provided by the DSDT that was used to build the device tree 510 and the library 520.

It should be emphasized that many variations and modifications may be made to the above-described embodiments. All such modifications and variations are intended to be included herein within the scope of this disclosure and protected by the following claims.

1. A method for using a secondary system description table (SSDT), said method comprising:
providing a differentiated system description table (DSDT) and a first SSDT, the first SSDT including information corresponding to a first device; and
using the DSDT and the first SSDT to build an ACPI namespace that includes a first ACPI functional routine and a device tree lacking at least the first ACPI functional routine.

2. The method of claim 1, further comprising:
providing a second SSDT corresponding to a second device; and
wherein using the DSDT and the first SSDT comprises:
using the DSDT, the first SSDT and the second SSDT to build an ACPI namespace that includes a first ACPI functional routine and a device tree lacking at least the first ACPI functional routine.

3. The method of claim 2, further comprising:
using the device tree and the first ACPI functional routine to obtain information corresponding to the first device.

4. The method of claim 3, wherein using the device tree comprises:
analyzing the device tree with an operating system; and
initiating a call to the first ACPI functional routine.

5. The method of claim 3, further comprising:
providing information corresponding to the first device to the operating system in response to the call.

6. A method for using a secondary system description table (SSDT), said method comprising:
providing a computer system having a differentiated system description table (DSDT), a first secondary system description table (SSDT), a first device and a memory; and
using the DSDT and the first SSDT to build an ACPI namespace of the memory such that the memory includes a first ACPI functional routine and a device tree lacking at least the first ACPI functional routine.

7. The method of claim 6, wherein the first SSDT includes information corresponding to the first device.

8. The method of claim 6, further comprising:
providing a second device; and
providing a second SSDT corresponding to the second device.

9. The method of claim 8, wherein using the DSDT and the first SSDT comprises:
using the DSDT, the first SSDT and the second SSDT to build an ACPI namespace that includes a first ACPI functional routine and a device tree lacking at least the first ACPI functional routine.

10. The method of claim 8, wherein providing a second device comprises installing the second device in the computer system.

11. The method of claim 6, wherein the memory comprises a read-only memory (ROM) and a main memory; and
wherein the first SSDT is stored in the ROM.

12. The method of claim 11, further comprising:
loading the first SSDT into main memory.

13. A system comprising:
an advanced configuration and power interface (ACPI) system operative to access a differentiated system description table (DSDT) and a first secondary system description table (SSDT) and to build a library and a device tree, the library including at least a first ACPI functional routine, the device tree lacking at least the first ACPI functional routine.

14. The system of claim 13, wherein the first SSDT corresponds to a first device; and
wherein the ACPI system further comprises:
a second SSDT corresponding to a second device, the second SSDT being operative to provide information for building the device tree.

15. The system of claim 13, further comprising:
means for storing the ACPI system.

16. The system of claim 13, further comprising:
a memory storage device, the ACPI system being stored on the memory storage device.

17. The system of claim 16, further comprising:
a computer system; and
wherein the memory storage device is associated with the computer system.

18. A computer-readable medium having a computer program for using a secondary system description table (SSDT), said computer program comprising:
logic configured to use a differentiated system description table (DSDT) and a first SSDT, the first SSDT including information corresponding to a first device to build an ACPI namespace that includes a first ACPI functional routine and a device tree lacking at least the first ACPI functional routine.

19. The computer-readable medium of claim 18, further comprising:
logic corresponding to a second SSDT; and
wherein the logic configured to use a differentiated system description table is operative use the logic corresponding to the second SSDT to build the ACPI namespace.

20. The computer-readable medium of claim 18, further comprising:
logic configured to provide information corresponding to the first device in response to a call from an operating system.
